(19) United States
(12) Patent Application Publication
(10) Pub. No.: US 2026/0300221 A1
(43) Pub. Date: Oct. 1, 2026

(54) METHOD AND DEVICE FOR CONVERTING SEISMIC DATASETS

(71) Applicant: FNV IP B.V., Leidschendam (NL)

(72) Inventors: Victor SAVENIJE, Leidschendam (NL); Sanket BHATTACHARYA, Leidschendam (NL)

(73) Assignee: FNV IP B.V., Leidschendam (NL)

(21) Appl. No.: 19/477,744

(22) PCT Filed: Apr. 24, 2024
(86) PCT No.: PCT/EP2024/061193

§ 371 Date: Oct. 22, 2025

(30) Foreign Application Priority Data
May 16, 2023 (NL) 2034841

(51) Int. Cl. G06F 16/11

(52) U.S. Cl. CPC G06F 16/116

(57) ABSTRACT

A method for converting a first dataset comprising a first plurality of first data samples to a second dataset comprising a second plurality of second data samples is disclosed. The first data samples are regularly spaced from each other by a first sampling interval, the second data samples are regularly spaced from each other by a second sampling interval, the first sampling interval is defined differently than the second sampling interval, the first and second data samples are seismic data samples. The method is performed by a processor and comprises the steps of: obtaining a further sampling interval to be used as the second sampling interval; for each one of the second data samples, deriving the second data sample by computing the second data sample from one or more first data samples using an interpolation method, the one or more first data samples being selected based on at least the first sampling interval and the further sampling interval. Unlocking insights from Geo-Data, the present invention further relates to improvements in sustainability and environmental developments: together we create a safe and liveable world.

### FIELD OF THE INVENTION

The present disclosure generally relates to the field of seismic data processing, and more specifically to a method and a device for converting a first seismic dataset to a second seismic dataset with a sampling interval defined differently than a sampling interval of the first seismic dataset, to a device converting a first dataset comprising a first plurality of first data samples to a second dataset comprising a second plurality of second data samples, to a method for merging a plurality of first data files comprising a first plurality of first data samples defined by a first sampling interval, and to a computer program product.

### BACKGROUND OF THE INVENTION

Seismic data is data collected from the subsurface of the Earth using seismic methods. Seismic methods involve generating sound waves or vibrations that travel through the Earth's crust and recording the response of the subsurface layers to these waves. The resulting seismic data can be used to create images of the subsurface, and to study the geological structures and properties of the Earth's crust.

As an exemplary seismic method, seismic reflection is used to collect seismic data such that images of the subsurface of the Earth can be obtained. Geoscientists can use seismic reflection profiles to gain insights into the subsurface geology of an area, which can be used for a variety of purposes, including shallow geo-hazard studies for wind farms, oil and gas exploration, mineral exploration, and geological mapping.

Seismic reflection involves sending seismic waves into the ground and recording reflected waves that bounce back to the surface. The reflected waves are recorded by an array of sensors, which are then processed using a software to create a two-or three-dimensional image of the subsurface layers.

A standard data format for saving seismic data is the called SEG-Y format, which contain a variety of information, including the seismic data itself, as well as information about the data acquisition parameters, such as the number of channels, the sampling rate, the recording format and so on.

One of the key advantages of the SEG-Y format is its flexibility. The format can accommodate a wide range of acquisition and processing parameters and can be easily read and processed by a variety of software applications.

The SEG-Y format is therefore widely used and allows for easy sharing, exchanging, and processing of seismic data. It also has good portability and interoperability. In the seismic exploration industry, the SEG-Y format is a popular choice for storing and exchanging seismic data between different companies and research groups.

However, some seismic data is stored in formats other than the SEG-Y format, which means that processing parameters may not be defined in exactly the same way as in the SEG-Y data files. As a result, processing and analysis of such seismic data is usually performed using specialized software and it is not possible to use such seismic data directly in software or processing tools designed for processing SEG-Y format seismic data. In other words, such seismic data, when not converted to the SEG-Y format, cannot be feasibly used by software or processing tools designed for processing SEG-Y format seismic data.

Therefore, there is the need of a method for converting the non-SEG-Y format seismic data into the standard SEG-Y format, allowing the non-SEG-Y format seismic data to be used and/or integrated into processing tools in an easier manner.

### BRIEF SUMMARY OF THE INVENTION

According to one aspect of the present disclosure, there is presented a method for converting a first dataset comprising a first plurality of first data samples to a second dataset comprising a second plurality of second data samples, the first data samples regularly spaced from each other by a first sampling interval, the second data samples regularly spaced from each other by a second sampling interval, the first sampling interval being defined differently than the second sampling interval, the first and second data samples being seismic data samples, the method performed by a processor and comprising the steps of:
obtaining a further sampling interval to be used as the second sampling interval;
for each one of the second data samples, deriving the second data sample by computing the second data sample from one or more first data samples using an interpolation method, the one or more first data samples being selected based on at least the first sampling interval and the further sampling interval.

For the purpose of making better use of the first dataset having or comprising first data samples not represented or stored in a commonly known or standard data format, such as seismic data which is stored in a non-SEG-Y format, it is desirable that such a first dataset can be converted or transferred to a second dataset in the standard data format, while ensuring the precision and accuracy of second data samples of the thus obtained second dataset.

In working on the conversion, inventors of the present disclosure have the insight that a first dataset comprising a first plurality of first seismic data samples which are spaced from each other by a first sampling interval that is not explicitly defined can be converted to a second dataset comprising a second plurality of second seismic data samples which are spaced from each other by a second sampling interval which is explicitly specified or known by using an interpolation method.

To this end, a sampling interval equivalent to a second sampling interval as used in the second dataset is obtained first. This newly obtained sampling interval will be the basis for deriving the second data samples of the second dataset from the first data samples of the first dataset.

After obtaining or defining the sampling interval equivalent to the second sampling interval of the second dataset, each one of the second data samples of the second dataset is derived from one or more first data samples by way of an interpolation method.

The interpolation method is used such that an accurate value is computed for each one of the second data samples of the second dataset. The one or more first data samples for computing a second data sample are selected from the first dataset based on the first sampling interval, which is only implicitly defined in the first dataset, and the sampling interval equivalent to the second sampling interval.

By using the above method of the present disclosure, a second dataset comprising of second data samples with values that are accurately or precisely reconstructed from the available first data samples of the first dataset is obtained. Interpolating artifact as caused by the sampling interval of the first dataset is effectively eliminated in the second dataset.

The second dataset can then be processed using a readily available processing tool to derive information that is interested by a person skilled in the art.

In an example of the present disclosure, the method further comprises the following step prior to the obtaining step:
importing a data file comprising the first dataset.

As can be contemplated by those skilled in the art, the first dataset, such as seismic data which is not stored in a standard data format, maybe part of a data file. In addition to the first dataset, the data file may comprise further information defining data acquisition parameters, such as for example a sampling frequency, a record length and so on. The additional information may also be used in the conversion of the first dataset to the second dataset.

In an example of the present disclosure, the data file comprises a block header defining a sampling frequency of the first data samples, the obtaining step comprising:
deriving the further sampling interval from the sampling frequency of the first data samples.

In practice the first data samples of the first dataset are obtained or recorded according to a sampling frequency, which may be recorded in a block header of the data file. By taking the reciprocal of the sampling frequency, a further sampling interval is obtained. The thus obtained further sampling interval may be used directly as the second sampling interval of the second dataset.

Some applications may require that the second sampling interval is kept as an integer. In this case, the sampling interval derived from the sampling frequency is rounded up or down to obtain an integer second sampling interval. Such conversion is straightforward and consumes little computation resources.

In an example of the present disclosure, the second known sampling interval is specified by a user, the obtaining step comprises:
setting the second sampling interval as the further sampling interval.

A user performing the data processing may also specify a sampling interval that is desired. In this case, the second sampling interval is specified directly by the user.

In an example of the present disclosure, the second sampling interval is an integer sampling interval with microsecond precision.

Specifically for seismic data processing, the SEG-Y format in rev 0 and rev 1 requires that the sampling interval between the data samples is an integer and has a microsecond precision. This is needed to ensure that the second dataset obtained via the conversion conforms to the SEG-Y requirements per SEG-Y rev 1 and rev 0.

In an example of the present disclosure, wherein a starting time of the second plurality of second data samples is specified by a user.

In another example of the present disclosure, wherein an ending time of the second plurality of second data samples is specified by the user.

It is also possible for the user to specify the start and end times of the second dataset. When the second dataset comprises seismic data in SEG-Y format, care is taken to ensure start time is an integer millisecond which is the standard format of recording delay in SEG-Y.

The start and the start and end time of the second plurality of the second data samples may also be equal to the start and end time of the first data samples, though this may not always be preferred by the user. And this does not necessarily mean that conversion is not necessary.

In an example of the present disclosure, the deriving step comprises:
locating the one or more first data samples relevant for the second data sample;
computing a value of the second data sample from the one or more first data samples using the interpolation method.

As can be contemplated by those skilled in the art, the one or more first data samples used for computing a value of a corresponding second data samples can be determined based on the original first sample interval of the first dataset and the sampling interval which is equivalent to the second sampling interval of the second dataset. For each of the second data samples of the second dataset, one or more first data samples of the first dataset are selected or located. It will be understood that a more precise second data sample can be derived when the computation is based on more first data samples.

In an example of the present disclosure, the interpolation method is a linear interpolation method.

In an alternative example of the present disclosure, the interpolation method is a spline interpolation method.

The linear and spline interpolation methods are well known in the art and can be readily used in the present disclosure to reconstruct the second dataset from the first dataset.

In an example of the present disclosure, the second data file is a SEG-Y data file, the first data file is a non-SEG-Y data file.

The above-described method can be advantageously used to convert a seismic data file having data not in the non-SEG-Y format to a seismic data file in the SEG-Y data format. The second dataset obtained according to the present disclosure comprises second data samples which accurately represent the original first data samples in the first dataset. Such a second dataset may be conveniently processed using an available processing tool designed for the SEG-Y data.

In a second aspect of the present disclosure, there is presented a device converting a first dataset comprising a first plurality of first data samples to a second dataset comprising a second plurality of second data samples, the first data samples regularly spaced from each other by a first sampling interval, the second data samples regularly spaced from each other by a second sampling interval, the first sampling interval being defined differently than the second sampling interval, the first and second data samples being seismic data samples, the device comprising a processor configured to perform the method according to the first aspect of the present disclosure.

In a third aspect of the present disclosure, there is presented a method for merging a plurality of first data files comprising a first plurality of first data samples defined by a first sampling interval, comprising the steps of:
merging all the first data files to a one single file; and
converting the single file to a second data file comprising a second plurality of second data samples defined by a second sampling interval defined differently than the first sampling interval according to the method of the first aspect of the present disclosure, wherein the first and second data samples being seismic data samples.

In an example of the present disclosure, the second data file is a SEG-Y data file, the first data file is a non-SEG-Y data file.

In a fourth aspect of the present disclosure, a computer product is provided, comprising a computer readable storage medium storing instructions which, when executed on at least one processor, cause the at least one processor to carry out the method according to the first aspect of the present disclosure.

The above mentioned and other features and advantages of the disclosure will be best understood from the following description referring to the attached drawings. In the drawings, like reference numerals donate identical parts or parts performing an identical or comparable function or operation.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 schematically illustrates an exemplary data structure as defined by the SEG-Y Revision 2.0 Specification;

FIG. 2 schematically illustrates, in a flow chart type diagram, a method of converting a first dataset comprising seismic data samples in non-SEG-Y data format to a second dataset comprising data samples in SEG-Y data format in accordance with an embodiment of the present disclosure;

FIG. 3 schematically illustrates comparison, between the method of the present disclosure and a convention method, of interpolation artifact on a single trace.

FIGS. 4a and 4b respectively show a seismic reflection profile based on SEG-Y data obtained using a conventionally known conversion method and a seismic reflection profile based on SEG-Y data obtained using the method of the present disclosure.

FIG. 5 illustrates difference between interpolation artifact calculated based on SEG-Y data obtained respectively by using the conversion method of the present disclosure and a conventional conversion method.

FIGS. 6a and 6b respectively illustrate a seismic reflection profile based on SEG-Y data obtained using the conversion method of the present disclosure and a seismic reflection profile based on SEG-Y data obtained using a conventionally known conversion method, here heave compensation is applied to the raw data of both scenarios.

### DESCRIPTION OF ILLUSTRATIVE EMBODIMENTS

Embodiments contemplated by the present disclosure will now be described in more detail with reference to the accompanying drawings. The disclosed subject matter should not be construed as limited to only the embodiments set forth herein. Rather, the illustrated embodiments are provided by way of example to covey the scope of the subject matter to those skilled in the art.

The present disclosure is detailed below with reference to converting non-SEG-Y format dataset to SEG-Y dataset. Those skilled in the art will appreciate that the present disclosure is not limited to the described examples but is applicable for converting or transferring a seismic dataset in a format to a further seismic dataset in another format, in which sampling intervals of data samples in the two dataset are defined differently.

In the following descriptions, the terms “sampling interval” and “sampling rate” are used interchangeably.

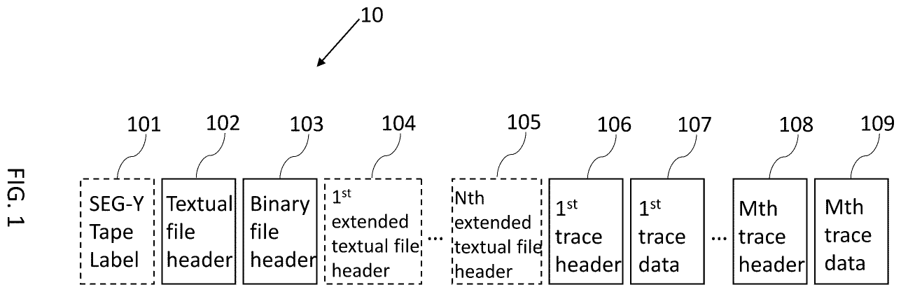

Referring to FIG. 1, in which data structure of a SEG-Y data file is schematically illustrated. FIG. 1 illustrates an exemplary data structure 10 as defined by the SEG-Y Revision 1.0 Specification. A SEG-Y file may comprise an optional SEG-Y tape label 101. Following that there are a 3200 byte textual file header 102 and a 400 byte binary file header 103. Additional 3200 byte extended textual file headers as indicated by references 104 to 105 may also be included.

Trace data blocks follow the identification headers. There may be a plurality of trace blocks, with each trace block comprising a 240 bytes binary trace identification header, as indicated by reference numerals 106 and 108, followed by trace data 107, 109 comprising seismic data samples. The trace data may have variable sizes.

Spacing between data samples in a SEG-Y files is defined by a sampling interval or a sampling rate, which is explicitly specified in the binary header of the SEG-Y files. In SEG-Y rev0 & rev1, the sampling interval is limited to microsecond precision. Although SEG-Y rev 2 allows for more precise sample interval, it is hardly used in the industry.

There is also seismic data which is stored not in the SEG-Y format. With those proprietary seismic data files, sometimes no directly or explicitly specified sampling interval is available; instead, the sampling interval is indirectly defined by a sampling frequency or record length in combination with a number of the data samples.

When processing such non-SEG-Y seismic data, it can happen that the sampling frequency cannot be converted to an integer sampling interval with microsecond precision as used in SEG-Y rev 0 and rev 1. It is therefore necessary to process the non-SEG-Y data and express those data in the SEG-Y format before any further manipulation or processing can be applied.

Based on the present disclosure, data samples in a non-SEG-Y data file are re-casted or interpolated to a sampling rate that can actually be expressed in a SEG-Y. The implementation of this interpolation depends on how a seismic signal is interpreted to be between the sampling points.

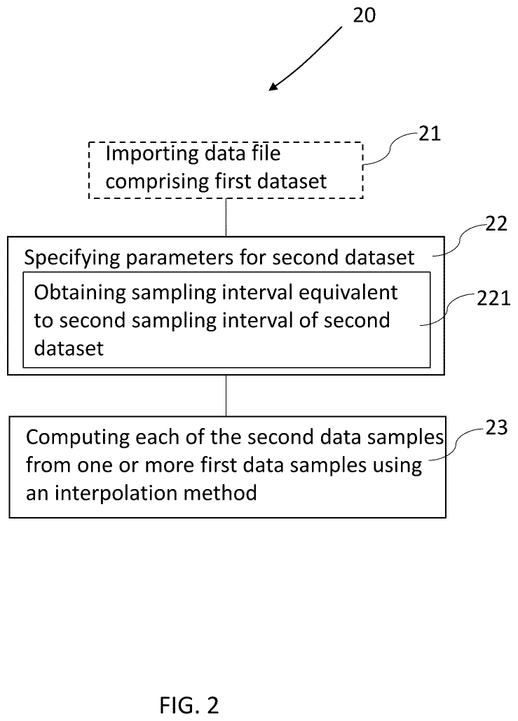

FIG. 2 schematically illustrates, in a flow chart type diagram, a method of converting a first dataset comprising seismic data samples in non-SEG-Y data format to a second dataset comprising data samples in SEG-Y data format in accordance with an embodiment of the present disclosure.

The method 20 of the present disclosure is for converting a first dataset comprising a first plurality of first data samples to a second dataset comprising a second plurality of second data samples, the first data samples are regularly spaced from each other by a first sampling interval, the second data samples regularly are spaced from each other by a second sampling interval. The first sampling interval and the second sampling interval are defined or specified differently, meaning not by exactly a same kind of parameter. For seismic applications, the first and second data samples are seismic data samples.

The method is performed by a processor, such as included in a remote or local computer, a portable device or any electronic device suitable for performing the method of the present disclosure.

At step 21, a data file comprising the first dataset of the first data samples is imported, if this is not already available in such as a software or a processing tool executed by the processor for performing the method. This specifically allows input of parameters of the original first dataset samples, including for example a sampling frequency, number of samples in the dataset and a recording delay.

The data samples of the imported data file are evenly spaced along a data axis with a spacing or sampling interval. The sampling interval, which is herein referred to as the first sampling interval, is however not directly available in the data file.

At step 22, parameters to be used for second dataset or the SEG-Y file are obtained, for example, as specified by the user. This step is performed for the user to optionally apply a range correction and to define or specify his or her own sample rate or sampling interval.

Range correction as used herein refers to making the SEG-Y data axis constant for all traces. The user may specify his or her own start and end times, which will make the SEG-Y data axis constant for all traces to be processed. Care is taken to ensure that the start time is an integer millisecond which is the standard format of recording delay in SEG-Y.

Step 22 specifically comprises a step 221 of obtaining a further sampling interval equivalent or to be used as the second sampling interval, which is the sampling interval to be used in the SEG-Y file.

The further sampling interval or sample rate that will be used in the SEG-Y file may be specified by the user.

Alternatively, depending on configuration, an optimal further sample rate is calculated based on the parameters as defined in the data file comprising the first dataset. As an example, the sampling frequency as defined in a header part of the data file imported at step 21 is used to calculate the sampling interval to be used in the second dataset or the SEG-Y dataset.

For conforming to the SEG-Y rev 0 and rev format, the second sampling interval is generally taken as an integer as close as possible to the reciprocal of the sampling frequency of the original non-SEG-Y file. The thus obtained sampling interval is considered as being equivalent to and used as the second sampling interval.

It is noted that the first sampling interval, that the implicit sampling interval of the original non-SEG-Y data file is generally different than the second sampling interval used in the SEG-Y file to be obtained after the conversion.

According to SEG-Y rev 0 and rev 1, the sample interval is defined on bytes 3217-3218 as an integer. The unit is microseconds (us) for time data, Hertz (Hz) for frequency data, meters (m) or feet (ft) for depth data.

The original data file may have the sample frequency defined also in its file header such as in a block header of a channel. The first sampling interval may also be defined by a duration of the samples, such as Measure Length. Together with the number of data samples in the original file, the first sampling interval may be derived.

At step 23, the first data samples in the original non-SEG-Y data file are converted or re-casted into second data samples in the SEG-Y file. For each of the second data samples, it is derived by computing the second data sample from one or more first data samples in the original non-SEG-Y data file using an interpolation method. The one or more first data samples are selected based on the implicit first sampling interval and the sampling interval equivalent to the second sampling interval.

When an interpolation technique is used, such as splines of a higher order than 1, values could lie outside the original data value range. If the data type format of the original non-SEG-Y data is the same as the requested/automatically selected SEG-Y data type format or consists larger integer type, then the values are clipped to the maximum integer data type format range.

Those skilled in the art will understand that seismic data can be misrepresented due to limits of the data format type. If the data is ‘clipped’, meaning there are data values that are at the limit of what can be represented by the integer type in which the data was stored, then the application will infer a better representation of the signal from the data surrounding the clipped samples, such as using interpolation by splines.

Data samples in the SEG-Y file to be obtained using the method of the present disclosure will be derived from one or more first data samples in the original non-SEG-Y file, depending on the number of data samples to be obtained for the SEG-Y file, the sampling interval of the SEG-Y file, in combination with the original sampling interval used. It also depends on the interpolation method used. As an example, the linear interpolation method requires samples, while quadratic splines require 3 samples.

As an illustrative example, when the original non-SEG-Y data file comprises 120 samples, and the SEG-Y data file to be obtained is supposed to have 150 data samples, it is not possible to map each data sample in the original non-SEG-Y file to a data sample in the SEG-Y file on a one-to-one basis.

As an example, sample No. 37 of the SEG-Y file is to be computed from samples 29, 30 and 31 of the non-SEG-Y file. It will be understood by those skilled in the art this is for illustrating purpose only and in practice the data samples can be selected in a more flexible manner.

The interpolation method used in the present disclosure can be a known interpolation method, such as a linear interpolation method or a spline interpolation method, which will not be elaborated herein.

The above-described method of the present disclosure may also be used to merge multiple non-SEG-Y files into a single SEG-Y file. This can be conveniently done when performing the conversion. The merging order is based on timestamps included in the non-SEG-Y files. In addition, with these time stamps, it can check if the files actually contain adjacent segments without a gap. Merging and conversion of the non-SEG-Y seismic data files are thereby performed in one process.

The method of the present disclosure as described above can be used to producing an errorless (i.e., without induced artifacts) raw data in the SEG-Y format from non-SEG-Y format seismic data files. Raw data, when converted using the present disclosure, can now also have correct heave information and headers are assigned to correct byte locations (i.e., 215-216). Smoothing is optionally applied to the heave data before conversion is applied to the seismic data.

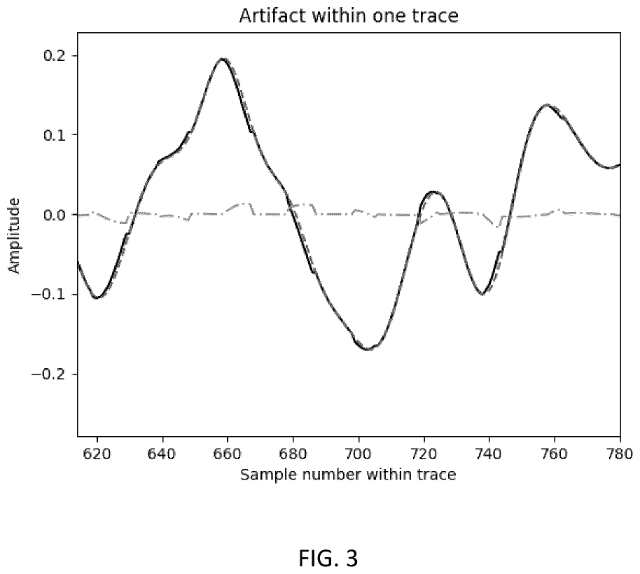

FIG. 3 schematically illustrates interpolation artifact on a single trace. Dashed curve of FIG. 3 is result obtained using the method of the present disclosure, solid curve is a result obtained using a convention method, and dash-dotted curve illustrates difference between the two methods. The result obtained using this method shows a smoothing signal, without kinks, which represent the true signal better. Comparison shows that an improvement of 12% in terms of accuracy is achieved by using the method of the present disclosure.

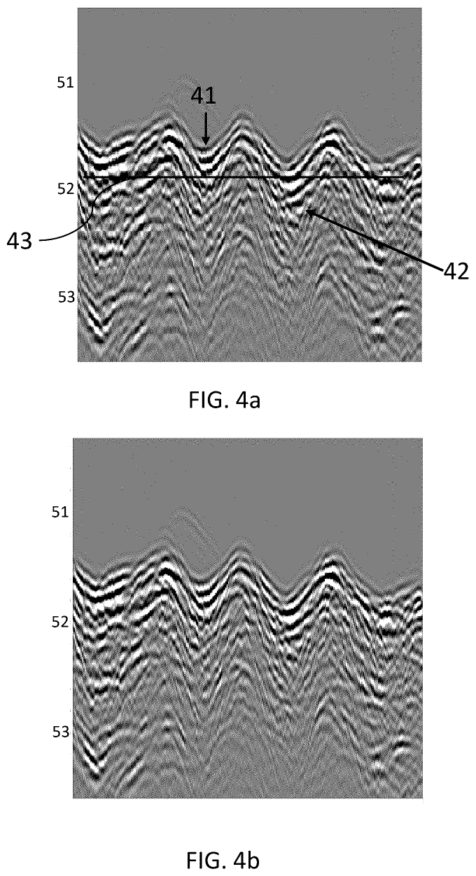

FIGS. 4a and 4b respectively show a reflection seismic profile in SEG-Y format obtained using a conventionally known conversion method and a reflection seismic profile in SEG-Y format obtained using the method of the present disclosure. In FIG. 4a interpolation artifacts 41, 42 and horizontal artifact 43 can be clearly seen. In contrast, no such artifacts are present in the reflection seismic profile of FIG. 4b.

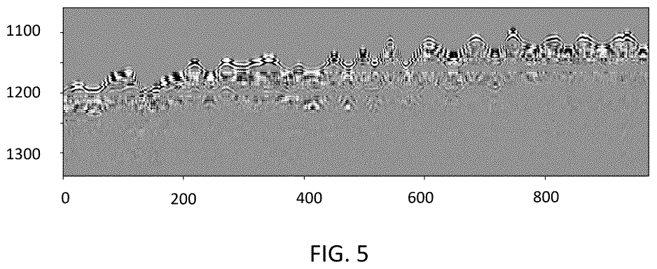

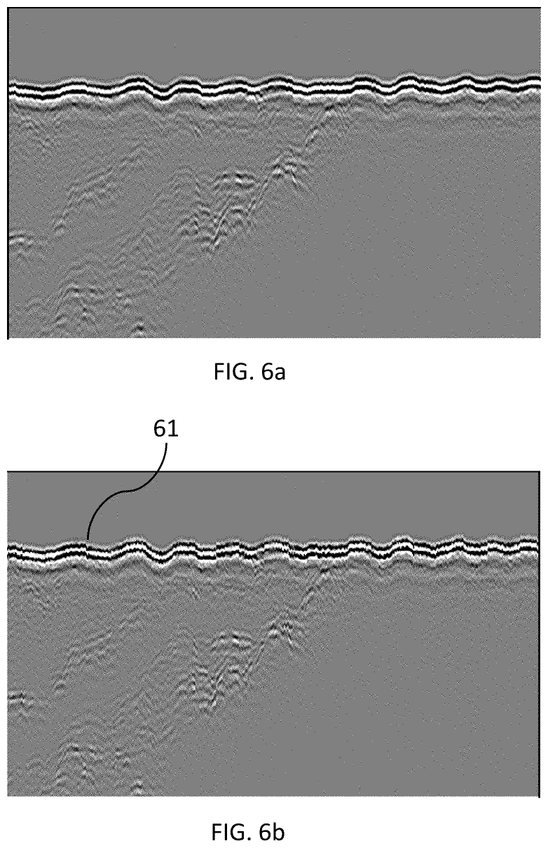

FIG. 5 schematically illustrates difference between interpolation artifact calculated based on SEG-Y data obtained respectively by using the conversion method of the present disclosure and a conventional conversion method. The figure shows that the difference found in each trace, as shown in FIG. 3, is present in all traces in such a way that the artifact appears at roughly the same arrival time. This causes the horizontal lines in FIG. 6b.

FIGS. 6a and 6b respectively illustrate a reflection seismic profile, in SEG-Y format, obtained using the conversion method of the present disclosure and a reflection seismic profile, in SEG-Y format, obtained using a conventionally known conversion method. Heave compensation is applied to the raw data of both scenarios. In FIG. 6b, some artifacts as indicated by 61 can still be seen, while such artifacts are not present in the seismic reflection profile of FIG. 4a. Because of the heave compensation, the artifact doesn't appear as horizontal lines anymore as seen in FIG. 6.

In FIGS. 4a, 4b, 5, 6a and 6b, the horizontal axis is trace number, and the vertical axis is the two-way travel time.

The method of the present disclosure can be integrated into a larger workflow, which is platform independent, such as by the use of a command line interface. This allows a robust way to feasibly use data originating from non-SEG-Y format seismic data.

The above method of the present invention, when used to convert non-SEG-Y format seismic data to SEG-Y format seismic data, allows for customization options, which makes it possible to specify exact format, that is, SEG-Y file format revision number, of the SEG-Y file obtained using the method of the present disclosure.

The non-SEG-Y format seismic data file may also be cut or split using the method of the present disclosure, which allows for smaller SEG-Y file size on the data.

The method also enables appliance to the SEG-Y file specification by for example appropriately/errorless writing SEG-Y trace header 215-216.

Errors in the timestamp interpolation when the file is acquired at midnight may also be eliminated by using the method of the present disclosure.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

1. A method for converting a first dataset comprising a first plurality of first data samples to a second dataset comprising a second-plurality of second data samples, the plurality of first data samples regularly spaced from each other by a first sampling interval, the plurality of second data samples regularly spaced from each other by a second sampling interval, the first sampling interval being defined differently than the second sampling interval, the plurality of first data samples and the plurality of second data samples being seismic data samples, the method comprising:
obtaining a further sampling interval to be used as the second sampling interval; and
for each one of the plurality of second data samples, deriving a respective second data sample from one or more first data samples of the plurality of first data samples using an interpolation method, the one or more first data samples being selected based on at least the first sampling interval and the further sampling interval.

2. The method according to claim 1, further comprising:
importing a data file comprising the first dataset.

3. The method according to claim 2, wherein the data file comprises a block header defining a sampling frequency of the plurality of first data samples, the method further comprising:
deriving the further sampling interval from the sampling frequency of the plurality of first data samples.

4. The method according to claim 1, wherein the second sampling interval is specified by a user, the method further comprising:
setting the second sampling interval as the further sampling interval.

5. The method according to claim 3, wherein the second sampling interval is an integer sampling interval with microsecond precision.

6. The method according to claim 1, wherein a starting time of the plurality of second data samples is specified by a user.

7. The method according to claim 1, wherein an ending time of the plurality of second data samples is specified by a user.

8. The method according to claim 1, further comprising:
locating the one or more first data samples relevant for the respective second data sample; and
computing a value of the respective second data sample from the one or more first data samples using the interpolation method.

9. The method according to claim 1, wherein the interpolation method is a linear interpolation method.

10. The method according to claim 1, wherein the interpolation method is a spline interpolation method.

11.-12. (canceled)

13. The method according to claim 1, further comprising:
merging first plurality of first data samples to a single file; and
converting the single file to a second data file defined by the second sampling interval defined differently than the first sampling interval.

14. The method according to claim 13, wherein the second data file is a SEG-Y data file, the single file is a non-SEG-Y data file.

15. (canceled)

16. A system for converting a first dataset comprising a plurality of first data samples to a second dataset comprising a plurality of second data samples, the plurality of first data samples regularly spaced from each other by a first sampling interval, the plurality of second data samples regularly spaced from each other by a second sampling interval, the first sampling interval being defined differently than the second sampling interval, the plurality of first data samples and the plurality of second data samples being seismic data samples, the system comprising:
at least one processor; and
at least one memory storing instructions, which when executed by the at least one processor, cause the system to:
obtain a further sampling interval to be used as the second sampling interval; and
for each one of the plurality of second data samples, derive a respective second data sample from one or more first data samples of the plurality of first data samples using an interpolation method, the one or more first data samples being selected based on at least the first sampling interval and the further sampling interval.

17. The system according to claim 16, further comprising instructions which when executed by the at least one processor, cause the system to:
import a data file comprising the first dataset.

18. The system according to claim 17, wherein the data file comprises a block header defining a sampling frequency of the plurality of first data samples, the system further comprising instructions which when executed by the at least one processor, cause the system to:
derive the further sampling interval from the sampling frequency of the plurality of first data samples.

19. The system according to claim 18, wherein the second sampling interval is an integer sampling interval with microsecond precision.

20. The system according to claim 16, wherein the second sampling interval is specified by a user, the system further comprising instructions which when executed by the at least one processor, cause the system to:
set the second sampling interval as the further sampling interval.

21. The system according to claim 16, wherein a starting time of the plurality of second data samples is specified by a user.

22. The system according to claim 16, wherein an ending time of the plurality of second data samples is specified by a user.

23. The system according to claim 16, further comprising instructions which when executed by the at least one processor, cause the system to:
locate the one or more first data samples relevant for the respective second data sample; and
compute a value of the respective second data sample from the one or more first data samples using the interpolation method.

24. The system according to claim 16, further comprising instructions which when executed by the at least one processor, cause the system to:
merge first plurality of first data samples to a single file; and
convert the single file to a second data file defined by the second sampling interval defined differently than the first sampling interval.

25. The system according to claim 24, wherein the second data file is a SEG-Y data file, the single file is a non-SEG-Y data file.
